(19) United States
(12) Patent Application Publication
(10) Pub. No.: US 2025/0201813 A1
(43) Pub. Date: Jun. 19, 2025

(54) ELECTRODE

(71) Applicant: TOYOTA JIDOSHA KABUSHIKI KAISHA, Toyota-shi (JP)

(72) Inventor: Chika NOGUCHI, Toyota-shi (JP)

(73) Assignee: TOYOTA JIDOSHA KABUSHIKI KAISHA, Toyota-shi (JP)

(21) Appl. No.: 18/892,791

(22) Filed: Sep. 23, 2024

(30) Foreign Application Priority Data
Dec. 15, 2023 (JP) 2023-212066

(51) Int. Cl. H01M 4/36; H01M 4/02; H01M 4/38; H01M 4/583

(52) U.S. Cl. CPC H01M 4/364; H01M 4/386; H01M 4/583; H01M 2004/021; H01M 2004/028

(57) ABSTRACT

The electrode includes a base material and an anode active material layer. The anode active material layer is disposed on a surface of the base material. The anode active material layer includes first graphite particles, second graphite particles, and Si particles. An aspect ratio of the first graphite particles is 6 to 20. An aspect ratio of the second graphite particles is 2.7 or less. In a cross-section parallel to a thickness direction of the anode active material layer, an orientation angle is 58° or greater.

### CROSS-REFERENCE TO RELATED APPLICATION

This application claims priority to Japanese Patent Application No. 2023-212066 filed on Dec. 15, 2023, incorporated herein by reference in its entirety.

### BACKGROUND

### 1. Technical Field

The present disclosure relates to an electrode.

### 2. Description of Related Art

Japanese Unexamined Patent Application Publication No. 2016-103347 (JP 2016-103347 A) discloses an anode including carbon particles and non-carbon particles.

### SUMMARY

There is room for improving cycling characteristics with respect to mixed systems of graphite particles and silicon-containing particles (hereinafter also referred to as “Si particles”). When charging, the particles can expand. When discharging, the particles can contract. Expansion behavior and contraction behavior may vary depending on the type of particle. Repeated expansion and contraction of the particles can alter layout of the particles. Alteration in the layout can cause, for example, interruptions in conductive paths, generation of particles that are isolated from conductive networks, and so forth. As a result, desired cycling characteristics may not be obtained.

An object of the present disclosure is to improve cycling characteristics.

1. An electrode includes
a base material, and an anode active material layer.
   The anode active material layer is disposed on a surface of the base material.
   The anode active material layer includes first graphite particles, second graphite particles, and silicon-containing particles.
   An aspect ratio of the first graphite particles is 6 to 20.
   An aspect ratio of the second graphite particles is 2.7 or less.
   In a cross-section parallel to a thickness direction of the anode active material layer, an orientation angle is 58° or greater.
   The orientation angle represents an average value of a first angle and a second angle. The first angle represents an angle formed between a long axis of the first graphite particles and the surface of the base material.
   The second angle represents an angle formed between a long axis of the second graphite particles and the surface of the base material.

The orientation angle is an index of an orientation state of the graphite particles in the anode active material layer. The orientation angle can assume a value from 0° to 90°. The greater the orientation angle is, the more the long axis of the graphite particles is considered to follow the thickness direction of the anode active material layer. For example, when the anode active material layer is formed, the graphite particles can be oriented by applying a magnetic field to the graphite particles. By orienting the graphite particles such that the orientation angle is 58° or greater, promotion of ion conduction in the thickness direction is anticipated.

Further, the anode active material layer includes two types of graphite particles. The first graphite particles have a relatively large grain size and a high aspect ratio. The second graphite particles have a relatively small grain size and a low aspect ratio. By orienting the first graphite particles, relatively large voids can be formed between the first graphite particles. When the first graphite particles are present alone, positions of the first graphite particles can shift toward adjacent void sides due to volume change during charging and discharging. When the first graphite particles are oriented in the thickness direction, the voids are adjacent to the first graphite particles in an in-plane direction. Thus, the first graphite particles will shift in the in-plane direction. Shifting of the first graphite particles in the in-plane direction may cause inconveniences such as interruption of the conductive path. Due to the presence of the second graphite particles in addition to the first graphite particles, the second graphite particles are anticipated to enter into the voids between the first graphite particles. It is anticipated that shifting of the first graphite particles will be inhibited by disposing the second graphite particles in the voids.

In addition, Si particles can also be disposed in the voids. Upon charging, Si particles can expand rapidly. Voids formed by combining the first graphite particles and the second graphite particles can take up the rapid expansion of the Si particles. Accordingly, expansion of the overall anode active material layer can be diminished during charging. Upon discharging, Si particles can contract rapidly. The Si particles and the second graphite particles are adjacent to each other in the voids, and accordingly it is thought particle isolation and structural collapse are unlikely to occur. Improvement in cycling characteristics, due to the synergy of the above effects, is anticipated.

2. The electrode according to the above “1” may include, for example, the following configuration. This is because the cycling characteristics may be improved by this configuration.

A grain size of the first graphite particles is 27 μm to 66 μm.

3. The electrode according to the above “1” or “2” may include, for example, the following configuration. This is because the cycling characteristics may be improved by this configuration.

A grain size of the second graphite particles is 5 μm to 22 μm.

4. The electrode according to any one of the above “1” to “3” may include, for example, the following configuration. This is because the cycling characteristics may be improved by this configuration.

A ratio of the grain size of the first graphite particles to the grain size of the second graphite particles is 2.58 to 11.60.

5. The electrode according to any one of the above “1” to “4” may include, for example, the following configuration. This is because the cycling characteristics may be improved by this configuration.

The anode active material layer includes the silicon-containing particles of which a mass fraction is 25% or less. A grain size of the silicon-containing particles is 11 μm or less.

Hereinafter, an embodiment of the present disclosure (which may hereinafter be abbreviated to “present embodiment”) and an example of the present disclosure (which may hereinafter be abbreviated to “present example”) will be described. However, the present embodiment and the present example do not limit the technical scope of the present disclosure. The present embodiment and the present example are exemplary in all respects. The present embodiment and the present example are not restrictive. The technical scope of the present disclosure includes all modifications that fall within the meaning and scope equivalent to the claims. For example, it is originally planned to optionally extract appropriate configurations from the present embodiment and optionally combine such configurations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view of an orientation angle;

FIG. 2 is a conceptual diagram showing an electrode according to the present embodiment; and

FIG. 3 is a table showing experimental results.

### DETAILED DESCRIPTION OF EMBODIMENTS

### Main Terms

“Aspect ratio” indicates the ratio of the long axis diameter to the short axis diameter. The long axis diameter represents the maximum Feret diameter. The short axis diameter represents the minimum Feret diameter. The largest and smallest ferret diameters of the individual particles are measured in the cross-sectional scanning electron microscope (SEM) images of the anode active material layers. The maximum Feret diameter and the minimum Feret diameter may be specified by image analysis software. The cross section is parallel to the thickness direction of the anode active material layer. The observation magnification can be adjusted according to the size of the particles. The observation magnification is, for example, 700 times. Graphite particles having an aspect ratio of 6 to 20 are considered “first graphite particles”. 2.7 Graphite particles having the following aspect ratio are considered “second graphite particles”.

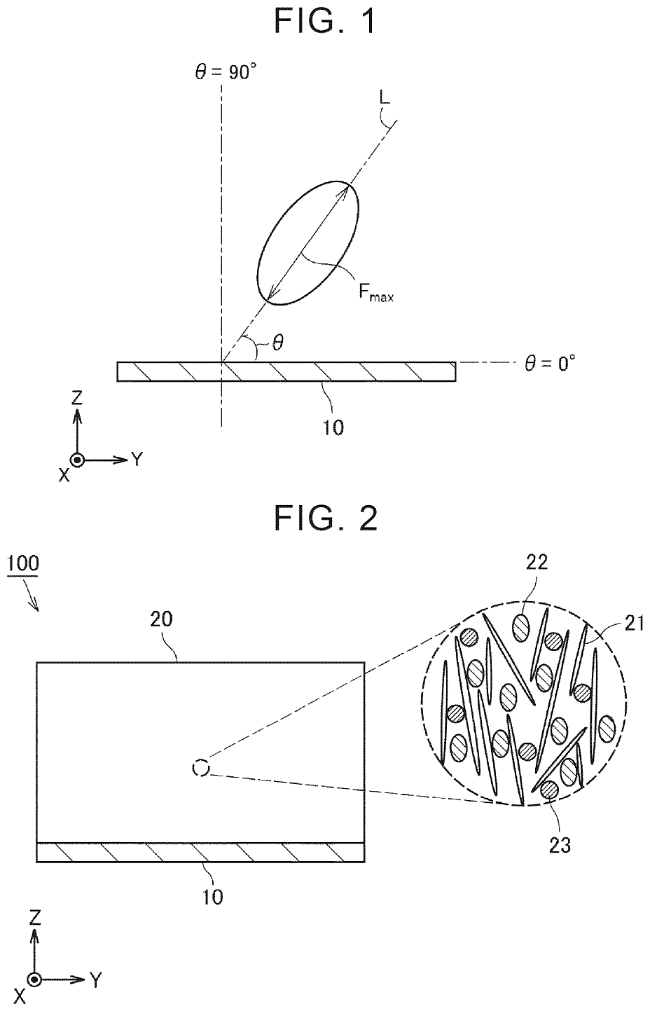

The “orientation angle” is measured by the following procedure. Five cross-sectional SEM images of the anode active material layers are prepared. Five cross-sectional SEM images are taken at different locations. FIG. 1 is an explanatory view of an orientation angle. In the image, the long axis L of the particle is identified. The long axis L is a straight line passing through the largest ferret diameter Fmax of the particle. When the particles are the first graphite particles, the angle θ formed between the long axis L and the surface of the base material 10 is the first angle. When the particles are second graphite particles, the angle θ formed is the second angle. The angle θ formed may take a value of 0° to 90°. The angle θ formed can be specified by image analysis software. In the five cross-sectional SEM images, the averages of the angle θ (first angle) formed by the first graphite particles and the angle θ (second angle) formed by the second graphite particles in the image are regarded as the orientation angles.

An element expressed in a singular form also includes plural forms of elements unless otherwise specified. For example, a “particle” includes not only “one particle” but also “a plurality of particles (particle group)” and “an aggregate of particles (powder)”.

“Grain size” refers to the average value of the maximum Feret size. In the five cross-sectional SEM images, the mean of the largest Feret diameters of the first graphite particles in the image is regarded as the “grain size of the first graphite particles”. The same applies to the grain sizes of the second graphite particles and Si particles.

“Silicon-containing particles (Si particles)” refer to particles comprising Si. Si particles may comprise, for example, at least one selected from the group consisting of Si, SiO, Si base alloys and Si—C. “Si—C” refers to composites comprising Si and carbon (C). In Si—C, Si may or may not form a compound with C. C may be amorphous, or may be crystalline.

The stoichiometric composition formula represents a representative example of a compound. The compound may have a non-stoichiometric composition. For example, “SiO” is not limited to compounds having a material weight ratio (molar ratio) of “Si:O=1:1”. “SiO” refers to compounds containing Si and O in any molar ratio, unless otherwise indicated. For example, the compound may be doped with a trace element. Some of Si and O may be substituted with another element.

Geometric terms should not be construed in a strict sense. Examples of the geometric terms include “parallel”, “vertical”, and “orthogonal”. For example, “parallel” may deviate somewhat from “parallel” in a strict sense. The geometric terms may include, for example, design, work, or manufacturing tolerances or variations. Dimensional relationships in each drawing may not match actual dimensional relationships. The dimensional relationships in each drawing may be changed to facilitate understanding of readers. For example, the length, width, and thickness may be changed. Some configurations may be omitted.

Numerical ranges such as “m % to n %” include upper and lower limits unless otherwise specified. That is, “m % to n %” indicates a numerical range of “m % or more and n % or less”. In addition, “m % or more and n % or less” includes “more than m % and less than n %”. The terms “greater than or equal to” and “less than or equal to” are represented by an equal sign inequality sign “<”. The terms “greater than” and “less than” are represented by inequality signs “<” that do not include equal signs.

### Electrode

FIG. 2 is a conceptual diagram illustrating an electrode according to the present embodiment. In FIG. 2, the Z-axis direction is the thickness direction. The X-axis direction and the Y-axis direction are in-plane directions, respectively. The electrode 100 is for a battery. The electrode 100 may be, for example, an anode for a monopolar battery. The electrode 100 may be for a bipolar battery, for example. The electrode 100 may be for a liquid-based lithium-ion battery, for example. The electrode 100 may be for an all-solid-state lithium-ion battery, for example. The electrode 100 includes a base material 10 and an anode active material layer 20.

### Base Material

The base material 10 supports the anode active material layer 20. The base material 10 may be, for example, a sheet. The thickness of the base material 10 may be, for example, 1 μm to 50 μm, or 5 μm to 30 μm. The base material 10 has conductivity. The base material 10 may include, for example, a metal foil. The base material 10 may include, for example, at least one selected from the group consisting of Cu, Ni, Zn, Pb, Al, Ti, Fe, Ag, Au, and conductive resins. The base material 10 may include, for example, a Cu foil, a Cu alloy foil, or the like. The base material 10 may have, for example, a multilayer structure. For example, the base material 10 may be formed by bonding a Cu foil and an Al foil.

### Anode Active Material Layer

The anode active material layer 20 is disposed on the surface of the base material 10. The anode active material layer 20 may be disposed only on one side of the base material 10. The anode active material layer 20 may be disposed on both surfaces of the base material 10. In the case where the electrode 100 is for a bipolar battery, the anode active material layer 20 may be disposed on one surface (the front surface) of the base material 10, and the positive electrode active material layer (not shown) may be disposed on the other surface (the rear surface). The thickness of the anode active material layer 20 may be, for example, 10 μm to 1000 μm, or 100 μm to 500 μm.

The anode active material layer 20 includes first graphite particles 21, second graphite particles 22, and Si particles 23. The first graphite particles 21, the second graphite particles 22, and Si particles 23 are each an anode active material. The first graphite particles 21 and the second graphite particles 22 include graphite. The graphite may be artificial graphite or natural graphite. The first graphite particles 21 and the second graphite particles 22 may further include, for example, low crystalline carbon, amorphous carbon, and the like as long as the graphite is contained. The first graphite particles 21 and the second graphite particles 22 may contain components other than graphite. In this case, the mass fraction of graphite in the first graphite particles 21 and the second graphite particles 22 may be, for example, 50% or more, 60% or more, 70% or more, 80% or more, 90% or more, or 95% or more.

### Mixing Ratio

The mixing ratio (mass ratio) of the first graphite particles 21 and the second graphite particles 22 may be, for example, from “first graphite particles:second graphite particles=9:1” to “first graphite particles:second graphite particles=1:9”. The mixing ratio may be, for example, from “first graphite particles:second graphite particles=9:1” to “first graphite particles:second graphite particles=5:5”. The mixing ratio may be, for example, from “first graphite particles:second graphite particles=8:2” to “first graphite particles:second graphite particles=6:4”.

### Aspect Ratio (AR1) of First Graphite-Particle

The first graphite particles 21 have an aspect ratio (AR1) of 6 to 20. The aspect ratio (AR1) may be, for example, 8 or more, 9 or more, 11 or more, or 19 or more. The aspect ratio (AR1) may be, for example, 19 or less, 11 or less, 9 or less, or 8 or less.

### Grain Size (D1) of First Graphite-Particle

The first graphite particles 21 may have a grain size (d1) of, for example, 27 μm to 66 μm. The grain size (d1) may be, for example, 33 μm or more, 34 μm or more, 46 μm or more, 57 μm or more, or 58 μm or more. The grain size (d1) may be, for example, 58 μm or less, 57 μm or less, 46 μm or less, 34 μm or less, or 33 μm or less. The grain size (d1) may be, for example, 30 μm to 50 μm.

### Aspect Ratio (AR2) of Second Graphite Particle

The second graphite particles 22 have an aspect ratio (AR2) of 2.7 or less. The aspect ratio (AR2) may be, for example, 2.2 or less, 2.1 or less, 1.9 or less, or 1.6 or less. The aspect ratio (AR2) may be, for example, 1 or more, 1.2 or more, 1.4 or more, or 1.6 or more.

### Grain Size (D2) of Second Graphite Particles

The second graphite particles 22 have, for example, a grain size (d2) of 5 μm to 22 μm. The grain size (d2) may be, for example, 18 μm or less, 16 μm or less, 14 μm or less, 12 μm or less, 10 μm or less, or 6 μm or less. The grain size (d2) may be, for example, 1 μm or more, 3 μm or more, 6 μm or more, 10 μm or more, or 12 μm or more. The grain size (d2) may be, for example, 5 μm to 12 μm.

Grain Size Ratio (d1/d2)

The grain size ratio (d1/d2) is a ratio of the grain size (d1) of the first graphite particles 21 to the grain size (d2) of the second graphite particles 22. The grain size ratio (d1/d2) may be, for example, 2.58 to 11.60. The grain size ratio (d1/d2) may be, for example, 2.83 or more, 3.40 or more, 4.83 or more, 5.50 or more, or 11.40 or more. The grain size ratio (d1/d2) may be, for example, 11.40 or less, 5.50 or less, 4.83 or less, 3.40 or less, or 2.83 or less. The grain size ratio (d1/d2) may be, for example, 3.30 to 7.25.

### Orientation Angle

In the anode active material layer 20, the orientation angle is 58° or more. The orientation angle may be, for example, 59° or more, 61° or more, 62° or more, 64° or more, or 66° or more. The orientation angle may be, for example, 90° or less, 80° or less, 70° or less, 66° or less, 64° or less, or 62° or less.

### Mass Fraction of Si Particles

The anode active material layer 20 includes, for example, 25% or less of Si particles 23 by mass fraction. The mass fraction of Si particles 23 may be, for example, 13% or less, or 3.5% or less. The mass fraction of Si particles 23 may be, for example, 1% or more, 2% or more, or 3.5% or more.

### Grain Size (d3) of Si Particles

Si particles 23 may have a grain size (d3) of, for example, 11 μm or less. The grain size (d3) may be, for example, 6 μm or less, or 1.5 μm or less. The grain size (d3) may be, for example, 0.5 μm or more, 1 μm or more, or 1.5 μm or more.

### Other Ingredients

The anode active material layer may further include a conductive material, a thickening material, a binder, or the like in addition to the anode active material. The conductive material may form an electron conduction path. The conductive material may include, for example, at least one selected from the group consisting of acetylene black (AB), Ketjen Black (registered trademark), vapor-grown carbon fiber (VGCF), carbon nanotube (CNT), and graphene flake (GF). The blending amount of the conductive material may be, for example, 0.1 to 10 parts by mass with respect to 100 parts by mass of the anode active material.

The thickener may impart viscosity to the anode paste. The thickener may include, for example, at least one selected from the group consisting of sodium alginate, carboxymethylcellulose (CMC), polyacrylic acid (PAA), and polyvinylpyrrolidone (PVP). The blending amount of the thickener may be, for example, 0.1 to 10 parts by mass with respect to 100 parts by mass of the anode active material.

The binder may bond the solids together. The binder may include, for example, at least one selected from the group consisting of styrene-butadiene rubber (SBR), acrylate-butadiene rubber (ABR), polyacrylonitrile (PAN), polyvinylidene fluoride (PVdF), polytetrafluoroethylene (PTFE), acrylic resin (acrylic acid ester copolymer), methacrylic resin (methacrylic acid ester copolymer), and polyvinyl alcohol (PVA). The blending amount of the binder may be, for example, 0.1 to 10 parts by mass with respect to 100 parts by mass of the anode active material.

### Preparation of Samples

### Fabrication of Electrodes

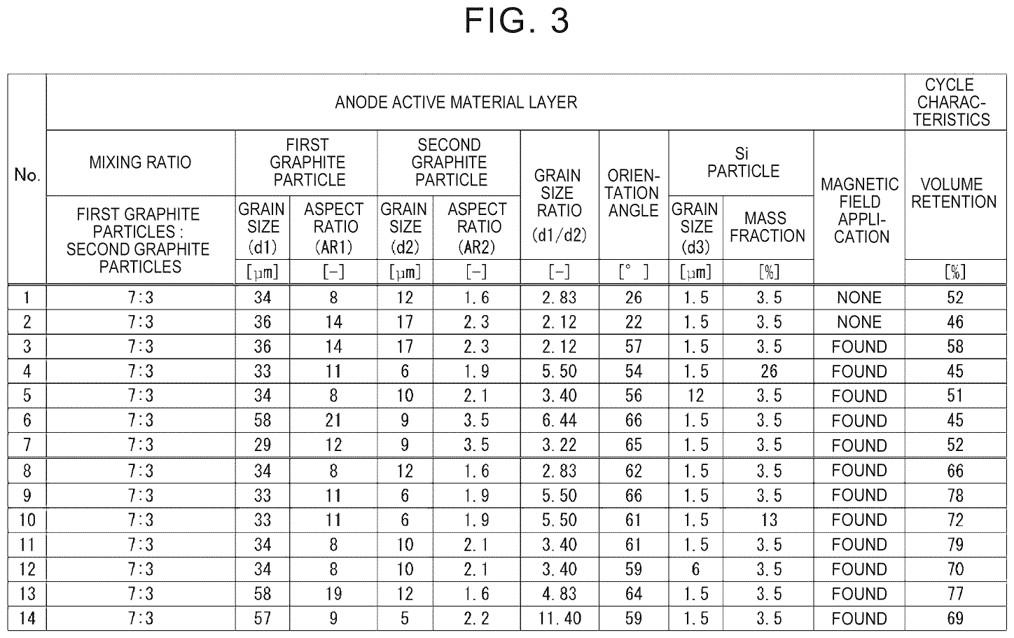

FIG. 3 is a table showing experimental results. No. 14 electrodes were fabricated from No. 1 by the following steps. A graphite mixture was prepared by mixing the first graphite particles and the second graphite particles in a “7:3 (mass ratio)”. The anode was prepared by mixing the graphite mixture, Si particles, SBR, CMC, the conductive material, and the ion-exchanged water. The blending of solids was “graphite-mixture:Si particles:SBR:CMC:conductive material=(98.3−a−b):a:0.5:1.2:b (by weight)”. As a base material, a Cu foil (thickness: 10 μm, long strip shape) was prepared. A coating film was formed by applying an anode paste to both surfaces of the base material. A magnetic field was applied to the coating film by passing the coating film through the gap between the pair of neodymium magnets. The magnetic flux density of the magnets was 0.5 T. After the application of the magnetic field, the coating film was dried to prepare an anode active material layer. An electrode (anode sheet) was produced by compressing the anode active material layer. In the anode sheet, the orientation angle and the like were measured by the above-described procedure.

### Preparation of Evaluation Cells

An evaluation cell (lithium ion battery) was prepared in the following procedure. The positive electrode paste was prepared by mixing LiNi_{1/3}Mn_{1/3}Co_{1/3}O₂ (grain size: 5 μm), AB, PVdF, and N-methyl-2-pyrrolidone. The solids formulation was “LiNi_{1/3}Mn_{1/3}Co_{1/3}O₂:AB:PVdF=92:5:3 (by weight)”. As a base material, an Al foil (thickness: 15 μm, long strip shape) was prepared. A coating film was formed by applying a positive electrode paste to both surfaces of the base material. The coating film was dried to prepare a positive electrode active material layer. A counter electrode (positive electrode sheet) was produced by compressing the positive electrode active material layer.

A separator was prepared. The separator included a resin porous film and a heat resistant layer. The resin porous membrane (thickness: 24 μm) had a three-layer structure (polyethylene layer/polypropylene layer/polyethylene layer). The heat-resistant layer (thickness: 4 μm) was formed on one side of the resin porous film.

A laminate was formed by laminating a positive electrode sheet, a separator, an anode sheet, and a separator. The laminated body was wound in a spiral shape to form a winding type power generation element. The power generating element was formed into a flat shape by being crushed in the radial direction. An external terminal was connected to the power generation element. The power generation element was housed in a metal case. An electrolyte solution was injected into the metal case. After injection of the electrolyte, the metal case was sealed. As described above, an evaluation cell was produced. The composition of the electrolytic solution was as follows.

### Electrolyte Composition

Solvent: “Ethylene carbonate:dimethyl carbonate:ethyl methyl carbonate=3:3:4 (volume ratio)”

Solute: LiPF₆ (density: 1 mol/L)

### Activation Process

First charging and discharging were performed under the following conditions.
Ambient temperature: 25° C.
Charge: constant current-constant voltage system, Current at constant current: ⅓ C, Voltage at constant voltage: 4.2 V, Cut current: 1/50 C
Discharge: constant current system, Current: ⅓ C, Cut-off voltage: 3 V

### Evaluation

### Measurement of Initial Volume

The initial capacity (initial discharge capacity) was measured by charging and discharging under the following conditions.
Charge: constant current-constant voltage system, Current at constant current: ⅓ C, Voltage at constant voltage: 4.1 V, Cut current: 1/50 C
Discharge: constant current system, Current: ⅓ C, Cut-off voltage: 3 V

### Cycle Characteristics

Charging and discharging of 300 cycles were performed with one cycle of charging and discharging under the following conditions.
Ambient temperature: 25° C.
Electric current: 0.5° C.
   Charge status (SOC): 0% to 100%

After 300 cycles, the post-cycle capacity was measured as well as the initial capacity. The capacity retention rate was determined by dividing the post-cycle capacity by the initial capacity. The higher the capacity retention ratio, the better the cycle characteristics are.

### Results

In the tables in FIG. 3, No. 8 to No. 14 have improved cycling properties compared to No. 1 to No. 7. No. 8 to No. 14 satisfy all of the conditions (a) to (c) below. No. 1 to No. 7 do not satisfy any one or more of the following conditions (a) to (c).
(a) The first graphite particles have an aspect ratio (AR1) of 6 to 20.
(b) The second graphite particle has an aspect ratio (AR2) of 2.7 or less.
(c) The orientation angle is 58° or more.

What is claimed is:

1. An electrode, comprising:
a base material; and
an anode active material layer, wherein
the anode active material layer is disposed on a surface of the base material,
the anode active material layer includes first graphite particles, second graphite particles, and silicon-containing particles,
an aspect ratio of the first graphite particles is 6 to 20,
an aspect ratio of the second graphite particles is 2.7 or less, and,
in a cross-section parallel to a thickness direction of the anode active material layer, an orientation angle is 58° or greater, in which
the orientation angle represents an average value of a first angle and a second angle,
the first angle represents an angle formed between a long axis of the first graphite particles and the surface of the base material, and
the second angle represents an angle formed between a long axis of the second graphite particles and the surface of the base material.

2. The electrode according to claim 1, wherein a grain size of the first graphite particles is 27 μm to 66 μm.

3. The electrode according to claim 1, wherein a grain size of the second graphite particles is 5 μm to 22 μm.

4. The electrode according to claim 1, wherein a ratio of the grain size of the first graphite particles to the grain size of the second graphite particles is 2.58 to 11.60.

5. The electrode according to claim 1, wherein:
the anode active material layer includes the silicon-containing particles of which a mass fraction is 25% or less; and also
a grain size of the silicon-containing particles is 11 μm or less.
